(19) United States
(12) Patent Application Publication
(10) Pub. No.: US 2008/0187344 A1
(43) Pub. Date: Aug. 7, 2008

(54) IMAGE FORMING APPARATUS AND METHOD FOR CONTROLLING FEEDING OF SHEETS

(75) Inventor: Ryuichi Yoshizawa, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/027,367

(22) Filed: Feb. 7, 2008

(30) Foreign Application Priority Data
Feb. 7, 2007 (JP) 2007-028444

(51) Int. Cl. G03G 21/14; G03G 15/00

(52) U.S. Cl. 399/76; 399/381

(57) ABSTRACT

An image forming apparatus, to which a paper-output device for processing a sheet after image formation is attached, includes a paper-feed unit for feeding a sheet for image formation; a detection unit for detecting a type of the sheet fed from the paper-feed unit; an image forming section for forming an image on the sheet fed from the paper-feed unit; and a control unit for determining a sheet-feed timing based on a sheet-processing time used by the paper-output device corresponding to a preset sheet type. If the preset sheet type matches the sheet type detected by the detection unit, the control unit determines the sheet-feed timing based on the sheet-processing time corresponding to the preset sheet type. If not, the control unit determines the sheet-feed timing based on the sheet-processing time corresponding to the sheet type detected by the detection unit.

### BACKGROUND OF THE INVENTION

1. Field of the Invention

The present invention relates to an image forming apparatus and a paper-output device to be attached to the image forming apparatus. More specifically, the present invention relates to processing of recording paper (sheets) performed by the image forming apparatus and the paper-output device.

2. Description of the Related Art

An image forming apparatus, to which an optional paper-output device for processing and outputting recording paper (a sheet) after image formation is attached, is known. In such an image forming apparatus, when forming an image on a sheet, the image forming apparatus requests the paper-output device to perform paper-output processing under certain paper-output conditions that specifies a paper-output bin and necessity of stapling. The paper-output device processes and outputs a sheet in accordance with the request of the paper-output processing from the image forming apparatus. This structure is disclosed in, for example, Japanese Patent Laid-Open No. 11-292390. In Japanese Patent Laid-Open No. 11-292390, a paper-output device to be attached to an image forming apparatus includes a plurality of paper-output bins, and calculates the time for each of the bins to move and sort sheets under certain paper-output conditions. The image forming apparatus schedules the processing of the subsequent sheets on the basis of the calculation result.

However, in the structure of Japanese Patent Laid-Open No. 11-292390, information about the sheet type is not taken into account when the image forming apparatus schedules the processing of the sheets. Therefore, depending on the sheet type or the sheet conveyance speed of the image forming apparatus, the processing performed by the paper-output device may not be synchronized with the processing performed by the image forming apparatus. Sheet types include normal paper, rough paper, glossy paper, cardboard, and thin paper.

When the paper-output device cannot start processing of a subsequent sheet, such as when the subsequent sheet arrives before the processing of a current sheet is completed, the subsequent sheet has to wait in the image forming apparatus. Thus, the operation of the image forming apparatus is limited.

### SUMMARY OF THE INVENTION

The present invention provides an image forming apparatus that synchronizes the processing performed by the image forming apparatus and the processing performed by the paper-output device by taking the sheet type into account. This reduces waiting time during image formation and improves processing efficiency. More specifically, information about sheet type is included in the paper-output reservation for the paper-output device. The paper-output device calculates the time when it is possible to receive a subsequent sheet. The calculation result is reflected in determining the timing to start forming an image in the image forming apparatus. The processing performed by the paper-output device and the processing performed by the image forming apparatus are thus synchronized, whereby an apparatus requiring a short waiting time in image formation and having a high processing efficiency can be provided.

An image forming apparatus, to which a paper-output device configured to process a sheet after image formation can be attached, includes a paper-feed unit configured to feed a sheet for image formation; a detection unit configured to detect a type of the sheet fed from the paper-feed unit; an image forming section configured to form an image on the sheet fed from the paper-feed unit; and a control unit configured to determine a sheet-feed timing based on a sheet-processing time used by the paper-output device corresponding to a preset sheet type. If the preset sheet type matches the type of the sheet detected by the detection unit, the control unit determines the sheet-feed timing on the basis of the sheet-processing time corresponding to the preset sheet type. If the preset sheet type does not match the type of the sheet detected by the detection unit, the control unit determines the sheet-feed timing based on the sheet-processing time corresponding to the type of the sheet detected by the detection unit.

A method for controlling feeding of a sheet in an image forming apparatus, to which a paper-output device configured to process a sheet after image formation can be attached, includes sending information about processing to be performed by the paper-output device to the paper-output device, the information including information about sheet type preset to a paper-feed unit of the image forming apparatus and information to control the paper-output device configured to perform paper-output processing of a sheet after image formation; calculating a sheet-processing time used by the paper-output device the information about the processing to be performed by the paper-output device; determining a sheet-feed timing in the image forming apparatus based on the calculated sheet-processing time; and starting feeding of a sheet in accordance with the sheet-feed timing set in the determining.

A method for controlling feeding of a sheet in an image forming apparatus, to which a paper-output device configured to process a sheet after image formation can be attached, includes sending information about processing to be performed by the paper-output device to the paper-output device, the information including information about sheet type preset to a paper-feed unit of the image forming apparatus; calculating a sheet-processing time used by the paper-output device based on the information about the processing to be performed by the paper-output device; detecting a type of a sheet fed from the paper-feed unit; renewing the sheet-processing time calculated in the calculating, if the sheet type preset to the paper-feed unit does not match the detected type of the sheet; and starting feeding of the sheet in accordance with the renewed sheet-processing time.

Further features of the present invention will become apparent from the following description of exemplary embodiments with reference to the attached drawings.

### BRIEF DESCRIPTION OF THE DRAWINGS

FIG. 1 shows the overall structure of a laser printer serving as an image forming apparatus.

FIG. 2 is a block diagram showing a system configuration of the image forming apparatus.

FIG. 3 is an exemplary table of settings of each of the paper-feed ports, showing sheet sizes and the corresponding sheet conveyance speeds.

FIG. 4 shows an operation flow of the controller, the external-paper-output-device control unit, and the engine control unit according to a first embodiment.

FIG. 5 shows an operation flow of the controller according to the first embodiment.

FIG. 6 shows an operation flow of the controller, the external-paper-output-device control unit, and the engine control unit according to a second embodiment.

FIG. 7 shows an operation flow of the controller according to the second embodiment.

FIG. 8 shows an operation flow of the controller, the external-paper-output-device control unit, and the engine control unit according to a third embodiment.

FIG. 9 shows an operation flow of the controller according to the third embodiment.

### DESCRIPTION OF THE EMBODIMENTS

Exemplary embodiments of the present invention will now be described in detail with reference to the attached drawings. It is to be noted that elements to be described in the following embodiments are just exemplary, and the technical scope of the present invention is defined by the claims attached herewith, not by the following embodiments.

An external paper-output device to be attached to an image forming apparatus according to the present invention includes an external-paper-output-device control unit capable of communicating with a controller. The external-paper-output-device control unit calculates the time when it is possible for the external paper-output device to receive a sheet. On the basis of the calculation result, the timing to form an image can be controlled. Although an image forming apparatus to be described below is one using an electrophotography process, the image forming apparatus is not limited thereto. For example, the external paper-output device may be attached to an ink-jet printer.

### First Embodiment

### Overall Structure

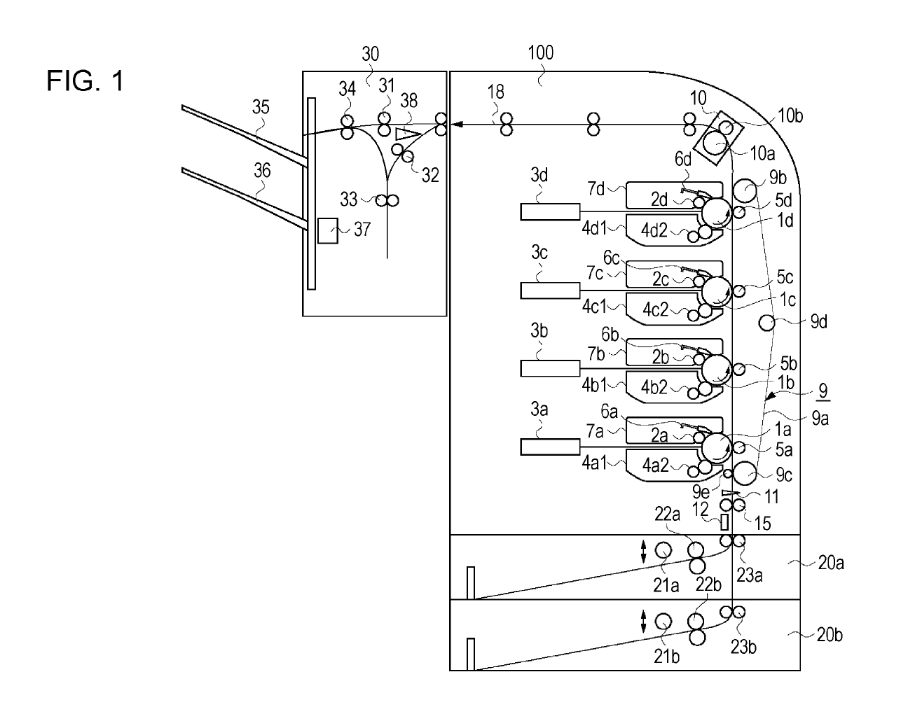

FIG. 1 shows the overall structure of a laser printer serving as an image forming apparatus. An image forming apparatus 100 includes photosensitive drums 1a, 1b, 1c, and 1d (generally denoted by reference numeral 1), which serve as image bearing members. Charging portion 2a, 2b, 2c, and 2d (generally denoted by reference numeral 2) are provided adjacent the photosensitive drums 1a, 1b, 1c, and 1d, respectively, and uniformly charge the surfaces thereof with the rotation. In addition, the image forming apparatus 100 includes exposure members 3a, 3b, 3c, and 3d (generally denoted by reference numeral 3) for emitting laser beams according to image data and forming electrostatic latent images on the photosensitive drums 1a, 1b, 1c, and 1d, and development members 4a, 4b, 4c, and 4d (generally denoted by reference numeral 4) for depositing toner on the electrostatic latent images form toner images. Further, the image forming apparatus 100 includes transfer members 5a, 5b, 5c, and 5d (generally denoted by reference numeral 5) for transferring the toner images deposited on the photosensitive drums 1 to sheets, and cleaning members 6a, 6b, 6c, and 6d (generally denoted by reference numeral 6) for removing the toner remaining on the surfaces of the photosensitive drums 1 after the toner images are transferred. Thus, an image forming section is provided.

Corresponding ones of the photosensitive drums 1, the charging portions 2, the development members 4, and the cleaning members 6 are gathered together to form cartridges, namely, process cartridges 7a, 7b, 7b, and 7d. A sheet fed from the paper-feed device 20a or 20b is conveyed by a conveying unit 9, which includes a conveyor belt, to the image forming section. The toner images of different colors are successively transferred to the sheet, whereby a multicolored image is formed thereon. A fixing unit 10 applies heat to the sheet to fix the image, and the sheet is output to the external paper-output device 30.

### Paper Feed Section

When sheets are fed from the paper-feed device 20a for image formation, a pick-up roller 21a separates and feeds the sheets on a piece-by-piece basis. The sheets are conveyed to the conveying unit 9 through conveying rollers 22a, intermediate conveying rollers 23a, and registration rollers 15. A sensor 11 detects a sheet, and is used to synchronize with the sheet and a image on the drum 1a.

When sheets are fed from the paper-feed device 20b for image formation, a pick-up roller 21b of a paper-feed device attached as an optional device (hereinafter referred to as an “optional paper-feed device”) separates and feeds the sheets on a piece-by-piece basis. The sheets are conveyed to the conveying unit 9 through conveying rollers 22b, intermediate conveying rollers 23b, the rollers 22b and 23b being included in the optional paper-feed device, the intermediate conveying rollers 23a, and the registration rollers 15.

### Image Forming Section

Each of the photosensitive drums 1, which serves as the image bearing member, includes a cylindrical body made of aluminum, on the outer surface of which an organic/optical photoconductor (OPC) layer is formed. The photosensitive drums 1 are rotatably supported at both ends by flanges. When a driving motor (not shown) applies a driving force to one end, the photosensitive drums 1 are rotated counterclockwise in FIG. 1.

The charging portions 2 are conductive rollers in the shape of a cylinder. By bringing the charging portions 2 into contact with the surfaces of the photosensitive drums 1, while applying a charging bias voltage from a power source (not shown), the surfaces of the photosensitive drums 1 become uniformly charged.

The exposure members 3 include polygonal mirrors, onto which laser diodes (not shown) emit image light corresponding to image signals.

The development members 4a, 4b, 4c, and 4d contact the surfaces of the photosensitive drums 1a, 1b, 1c, and 1d, respectively, and contact toner containers 4a1, 4b1, 4c1, and 4d1 containing black, cyan, magenta, and yellow toners, respectively. The development members 4a, 4b, 4c, and 4d include developing rollers 4a2, 4b2, 4c2, and 4d2, respectively, which are rotated by a driving portion (not shown), and develop images when a development bias voltage from a development bias power source (not shown) is applied thereto.

Further, transfer members 5a, 5b, 5c, and 5d are provided so as to touch internally a transfer conveyor belt 9a, which will be described below, at positions corresponding to the photosensitive drums 1a, 1b, 1c, and 1d, respectively. The transfer members 5a, 5b, 5c, and 5d are connected to each other by a transfer bias power source (not shown), and a positive electric field is applied to the sheets through the transfer members 5a to 5d and the transfer conveyor belt 9a. This electric field causes negatively charged toner images of different colors deposited on the photosensitive drums 1 to be successively transferred to the sheet in contact with the photosensitive drums 1, whereby a multicolored image is formed.

### Details of Sheet Conveying Operation

A sheet-type identification sensor 12 installed at a position between the intermediate conveying rollers 23a and the registration rollers 15 detects the type of a sheet fed from the paper-feed devices 20a or 20b. After the sheet type is detected, a controller 201 adjusts the sheet conveyance speed to a predetermined speed for the detected sheet type, and the conveying unit 9 conveys the sheet to the image forming section.

The transfer conveyor belt 9 serving as a sheet carrier and constituting the conveying unit 9 is extending over three rollers, namely, a driving roller 9b, and driven rollers 9c and 9d, so as to face all the photosensitive drums 1a to 1d. The transfer conveyor belt 9a is driven circularly by the driving roller 9b so that the transfer conveyor belt 9a picks up a sheet with its outer surface, which faces the photosensitive drums 1, utilizing electrostatic attraction and brings the sheet into contact with the photosensitive drums 1. Thus, the conveyor belt 9a conveys the sheet to transferring positions where the toner images deposited on the photosensitive drums 1 are transferred to the sheet.

Further, an attracting roller 9e configured to holding a sheet between the transfer conveyor belt 9a and attracting roller 9e, and to make the sheet stick to the transfer conveyor belt 9a is provided at the uppermost stream portion of the transfer conveyor belt 9a. When conveying a sheet, a voltage is applied to the attracting roller 9e. This generates an electric field between the attracting roller 9e and the driven roller 9c, which are facing each other. Thus, a dielectric polarization is generated between the transfer conveyor belt 9a and the sheet, thereby generating an electrostatic attraction force therebetween.

### Fixing Unit

The fixing unit 10 applies heat and pressure for fixation onto the toner images formed on a sheet. The fixing unit 10 includes a fixing belt 10a and an elastic pressurizing roller 10b. The elastic pressurizing roller 10b and a belt guiding member 10c, with the fixing belt 10a therebetween, provide a fixing nip having a predetermined contact pressure and a predetermined width. When the fixing nip is heated and regulated to a predetermined temperature, a sheet provided with an unfixed toner image is conveyed from the image forming section through the fixing belt 10a and the elastic pressurizing roller 10b, which are provided at the fixing nip, with the side provided with the image facing up, or facing the surface of the fixing belt 10a. When the sheet is held between and conveyed through the fixing belt 10a and the elastic pressurizing roller 10b, the sheet is heated by the fixing belt 10a, whereby the unfixed toner image thereon is heat-fixed.

### Paper-Output Section

The external paper-output device 30, which is optionally attached to the image forming apparatus, sorts and holds sheets with a first paper-output bin 35 and a second paper-output bin 36. A bin shift motor 37 vertically shifts the first paper-output bin 35 and the second paper-output bin 36 so that the sheets are output to the respective bins. A flapper 38 switches the direction of a sheet conveyed to the external paper-output device 30 to change the side of the sheet according to the instruction from the controller 201. When the controller 201 instructs the face-up output, the sheet is sent to one of the paper-output bins through rollers 31. On the other hand, when the controller 201 instructs the face-down output, the sheet is guided to rollers 32 and rollers 33 by the flapper 38. The sheet advances until its trailing end leaves the rollers 32. Then, the rollers 33 start to rotate reversely, and the sheet is sent between rollers 34 from its trailing end. The sheet is then sent to one of the paper-output bins.

During the conveyance of a sheet from the image forming apparatus 100 to the external paper-output device 30, the controller 201 detects the arrival of the leading end of the sheet at a sensor (paper-output-informing position) 18, and promptly informs the external paper-output device 30 of the occurrence of paper-output. The external paper-output device 30, upon receipt of the information, starts to prepare for reception of the sheet.

### System Configuration of the Image Forming Apparatus

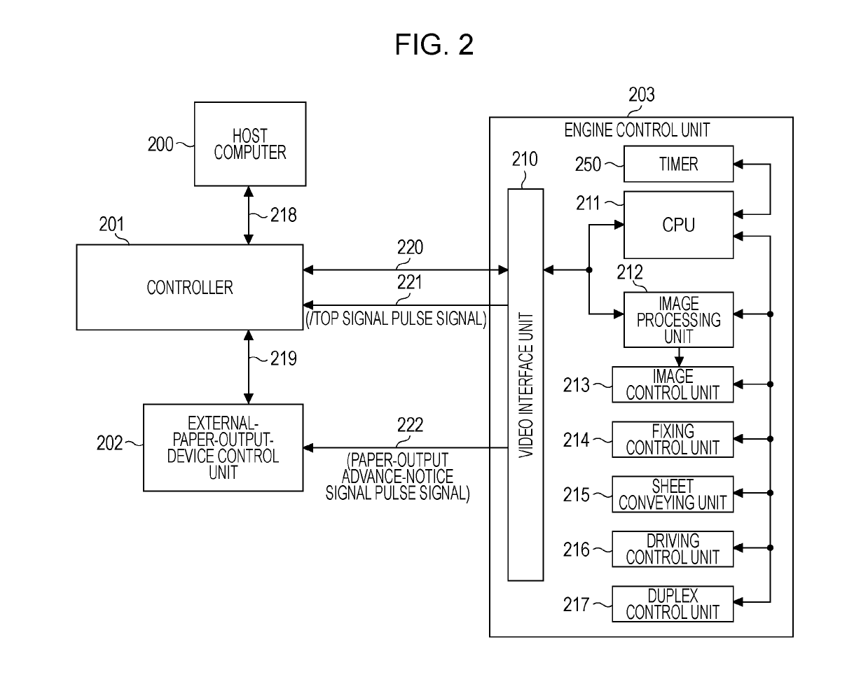

FIG. 2 is a block diagram showing a system configuration of the image forming apparatus.

An engine control unit 203 includes a central processing unit (CPU) 211, a timer 250 serving as a clocking unit, and a video interface unit 210. The video interface unit 210 serves as the interface between the engine control unit 203 and the controller 201, as well as the interface between the engine control unit 203 and the external-paper-output-device control unit 202.

In addition, the engine control unit 203 includes, as functional components constituting the image forming apparatus 100, an image processing unit 212, an image control unit 213 configured to control image formation, a fixing control unit 214, a sheet conveying unit 215, a driving control unit 216 configured to control a driving mechanism, and a duplex control unit 217 configured to control a duplex printing operation.

The controller 201 is capable of mutual communication with a host computer 200, the external-paper-output-device control unit 202, and the engine control unit 203. In FIG. 2, reference numeral 218 denotes communication between the host computer 200 and the controller 201, reference numeral 220 denotes communication between the controller 201 and the engine control unit 203, and reference numeral 219 denotes communication between the controller 201 and the external-paper-output-device control unit 202.

The controller 201 can acquire information about sheet type preset to respective paper-feed units (paper-feed ports).

A sheet type (status) and a sheet conveyance speed are preset to each of the paper-feed ports. The controller 201 can acquire, from the engine control unit 203, the sheet type and the sheet conveyance speed of the sheet conveyed to the external paper-output device 30.

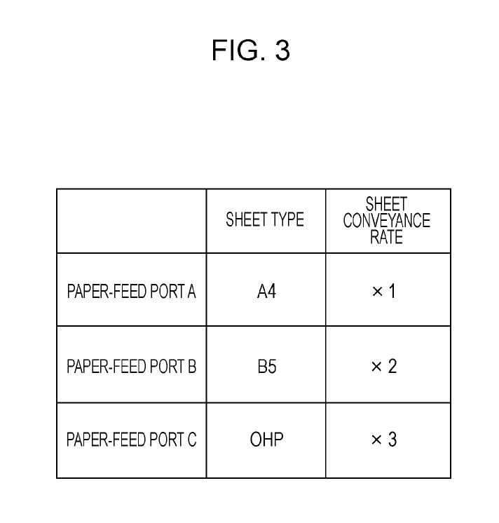

FIG. 3 is an exemplary table of settings of each of the paper-feed ports, showing sheet sizes and the corresponding sheet conveyance speeds. The table in FIG. 3 shows the following settings. Paper-feed port A: size=A4 (297×210 mm) and conveyance speed=X1; paper-feed port B: size=B5 (257×182 mm) and conveyance speed=X2; and paper-feed port C: sheet for an overhead projector (OHP) and conveyance speed=X3. The engine control unit 203 is capable of setting a sheet type and the sheet conveyance speed to each of the respective paper-feed ports.

The controller 201 sends a paper-output reservation containing the acquired information, i.e., the sheet type and/or the sheet conveyance speed, to the external-paper-output-device control unit 202. The external-paper-output-device control unit 202, taking the information contained in the paper-output reservation into account, calculates the precise time when the output of the subsequent sheet becomes possible (subsequent-sheet receiving time), and informs the controller 201 accordingly. This subsequent-sheet receiving time is calculated as the processing time used for processing a sheet according to the sheet type and the sheet conveyance speed in the external paper-output device 30.

The subsequent-sheet receiving time refers to a period of time from when the external paper-output device 30 starts processing of a first sheet output from the image forming apparatus 100 until it becomes possible for the external paper-output device 30 to process a second sheet subsequent to the first sheet.

The controller 201 also sends a print reservation to the engine control unit 203. The print reservation specifies a paper-feed port of the image forming apparatus 100 and an image-forming mode (image-forming rate). The controller 201, before making the print reservation or the paper-output reservation, acquires the information about sheet type preset to a paper-feed port to be specified in a print reservation from the engine control unit 203, and sends the paper-output reservation containing the acquired information about sheet type. The external-paper-output-device control unit 202, upon receipt of the paper-output reservation, calculates the time when it becomes possible to receive the subsequent sheet, taking the sheet conveyance speed corresponding to the specified sheet type and the time for the paper-output processing (switching of the paper-output bins, stapling, etc.) into account. The calculated time is then sent back to the controller 201 as a return status for the paper-output reservation.

The controller 201 receives image data and a print command from the host computer 200, analyzes the image data, and converts the image data into bitmap data. Then, the controller 201 sends a print reservation command, a print-start command, and a video signal corresponding to the converted bitmap data to the engine control unit 203 via the video interface unit 210, for each of the sheets to be printed.

The controller 201 sends the print reservation command to the engine control unit 203 according to the print command from the host computer 200. When a sheet is output to the external paper-output device 30, the controller 201 sends the print reservation command also to the external-paper-output-device control unit 202.

The external-paper-output-device control unit 202 calculates a subsequent-sheet receiving time representing a time when it is possible for the external paper-output device 30 to receive a next sheet, on the basis of the sheet type and the information to control the external paper-output device 30 that performs the output processing of a sheet after image formation.

The controller 201 calculates the timing of controlling the paper-feed unit on the basis of the subsequent-sheet receiving time. The engine control unit 203 controls the feeding of a sheet according to the calculated timing. That is, the controller 201 and the engine control unit 203 function as a control section for calculating the timing for starting feeding of a sheet and for controlling the feeding.

The controller 201 manages the print reservation command and the paper-output reservation command so as to associate them with each other, with respect to each of the sheets.

The engine control unit 203 starts feeding of a sheet upon receipt of the command instructing the start of printing, and temporarily stops when the sheet arrives at a sheet type detection position, where the sheet-type identification sensor 12, which is disposed on the conveying path, detects the sheet type.

After the detection of the sheet type, the engine control unit 203 restarts conveying the sheet and outputs a synchronizing signal (/TOP signal) 221 serving as a reference timing for outputting the video signal to the controller 201. Then, the engine control unit 203 starts printing, and outputs an advance-notice signal 222 to the external paper-output device 30 when the leading end of the sheet arrives at the sensor 18. When the sensor 18 detects the arrival of the leading end of the sheet, the image forming apparatus 100 outputs the advance-notice signal 222 that informs the external paper-output device 30 of occurrence of paper output. The external paper-output device 30 starts to prepare for reception of the sheet when the advance-notice signal 222 is output.

A timer 250 starts clocking when feeding of a first sheet starts, for example.

The engine control unit 203 determines whether a time clocked by the timer 250 serving as a clocking unit has exceeded a time equivalent to the timing for controlling the paper-feed unit.

If time clocked by the timer 250 has exceeded a time equivalent to the timing for controlling the paper-feed unit, feeding of a second sheet subsequent to the first sheet starts.

The controller 201 compares the sheet type detected by the sheet-type identification sensor 12 with the sheet type preset to the paper-feed unit. If the sheet types do not match as a result of the comparison, the external-paper-output-device control unit 202 renews the subsequent-sheet receiving time at the external paper-output device 30 according to the sheet type identified by the sheet-type identification sensor 12.

The controller 201 calculates the timing for controlling paper feeding on the basis of the renewed subsequent-sheet receiving time, and the engine control unit 203 controls the start of feeding a sheet according to the timing resulting from the calculation.

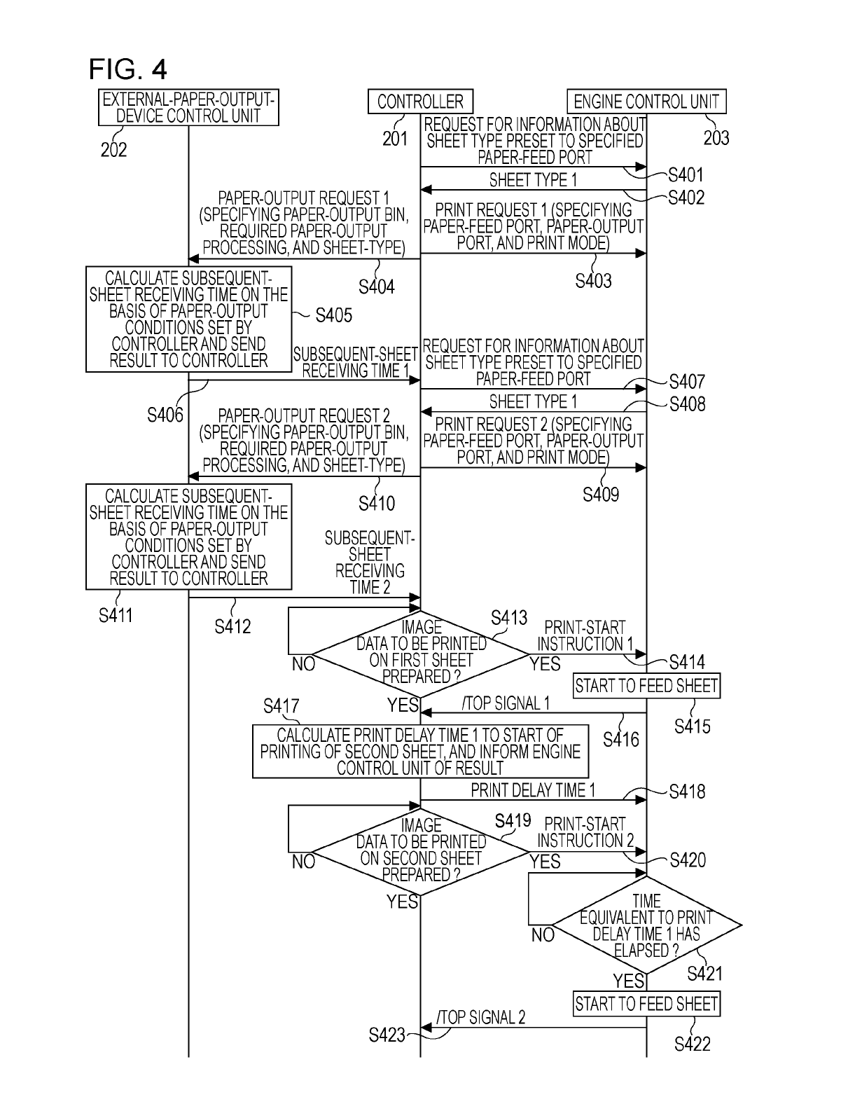

FIG. 4 shows an operation flow of the controller 201, the external-paper-output-device control unit 202, and the engine control unit 203.

The controller 201 sends a request for information about sheet type preset to a paper-feed port to be specified in a print reservation 1 to the engine control unit 203. The engine control unit 203, upon receipt of the request, sends the information about sheet type (for example, sheet type 1: normal paper) to the controller 201. The controller 201 acquires the information about sheet type (for example, sheet type 1: normal paper) preset to a paper-feed port to be specified in the print reservation 1, from the engine control unit 203 (S401 and S402).

Then, the controller 201 sends the print reservation 1 containing information necessary for printing specifying a paper-feed port, a paper-output port, a print mode, and the like to the engine control unit 203 (S403).

The controller 201 sends a paper-output reservation 1 containing the information about sheet type acquired from the engine control unit 203, in addition to paper-output conditions specifying a paper-output port (bin), required paper-output processing (stapling, etc.), and the like, to the external-paper-output-device control unit 202 (S404).

The external-paper-output-device control unit 202, upon receipt of the paper-output reservation 1, calculates a subsequent-sheet receiving time 1, which represents a period of time from when it finishes paper-output processing under the specified conditions on a first sheet conveyed at a conveyance speed corresponding to the specified sheet type to when it becomes possible to receive the next sheet (a second sheet). The external-paper-output-device control unit 202 informs the controller 201 of the calculated subsequent-sheet receiving time 1 (S405 and S406).

In the case of the second sheet, similarly to the first sheet, the controller 201 acquires the information about sheet type (for example, sheet type 1: normal paper) preset to a paper-feed port to be specified in a print reservation 2 from the engine control unit 203 (S407 and S408).

Then, the controller 201 sends the print reservation 2 containing information necessary for printing specifying a paper-feed port, a paper-output port, a print mode, and the like to the engine control unit 203 (S409).

The controller 201 sends a paper-output reservation 2 containing the information about sheet type acquired from the engine control unit 203, in addition to paper-output conditions specifying a paper-output port (bin), required paper-output processing (stapling, etc.), and the like, to the external-paper-output-device control unit 202 (S410).

The external-paper-output-device control unit 202, upon receipt of the paper-output reservation 2, calculates a subsequent-sheet receiving time 2, which represents a period of time from when it finishes paper-output processing under the specified conditions on the second sheet conveyed at a conveyance speed corresponding to the specified sheet type (for example, sheet type 1: normal paper) to when it becomes possible to receive the next sheet (a third sheet) (S411).

The external-paper-output-device control unit 202 informs the controller 201 of the calculated subsequent-sheet receiving time 2 (S412).

The controller 201, upon completion of preparation of image data sent from the host computer (S413—YES), sends a print-start instruction 1 for the first sheet to the engine control unit 203 (S414). The engine control unit 203 prepares to print upon receipt of the print-start instruction 1, starts feeding of a sheet from the specified paper-feed port, and outputs a synchronizing signal (/TOP signal 1) for controlling the timing with which the controller 201 outputs image data (S415 and S416).

The controller 201 outputs the image data in synchronization with the /TOP signal 1.

The controller 201, upon receipt of the /TOP signal 1, calculates a print delay time 1 between the subsequent-sheet receiving time 1 acquired from the external-paper-output-device control unit 202, at which reception of the second sheet becomes possible, and the start of the printing of the second sheet. The controller 201 then informs the engine control unit 203 of the print delay time 1 (S417 and S418).

The print delay time refers to a period of time from when the feeding of the first sheet starts to when the feeding of the second sheet starts. The timer 250, under the control of the CPU 211, starts clocking when the feeding of the first sheet starts, to determine whether a time equivalent to the print delay time has elapsed.

The controller 201 informs the engine control unit 203 of a print-start instruction 2 for the second sheet upon completion of preparation of image data to be printed on the second sheet (S419—YES, and S420).

The engine control unit 203 determines that, if the time equivalent to the print delay time 1 has already elapsed at the time of receipt of the print-start instruction 2 for the second sheet (S421—YES), the external paper-output device 30 can output the second sheet.

The time clocked by the timer 250 determines whether the time equivalent to the print delay time 1 has elapsed.

Then, the engine control unit 203 starts to feed the second sheet. If, it is determined that the time equivalent to the print delay time 1 has not elapsed in step S421 (S421—NO), the engine control unit 203 starts to feed the second sheet after the elapse of the time equivalent to the print delay time 1 (S422). The engine control unit 203 starts to feed the second sheet from the specified paper-feed port, and outputs a synchronizing signal (/TOP signal 2) for controlling the timing with which the controller 201 outputs image data (S423).

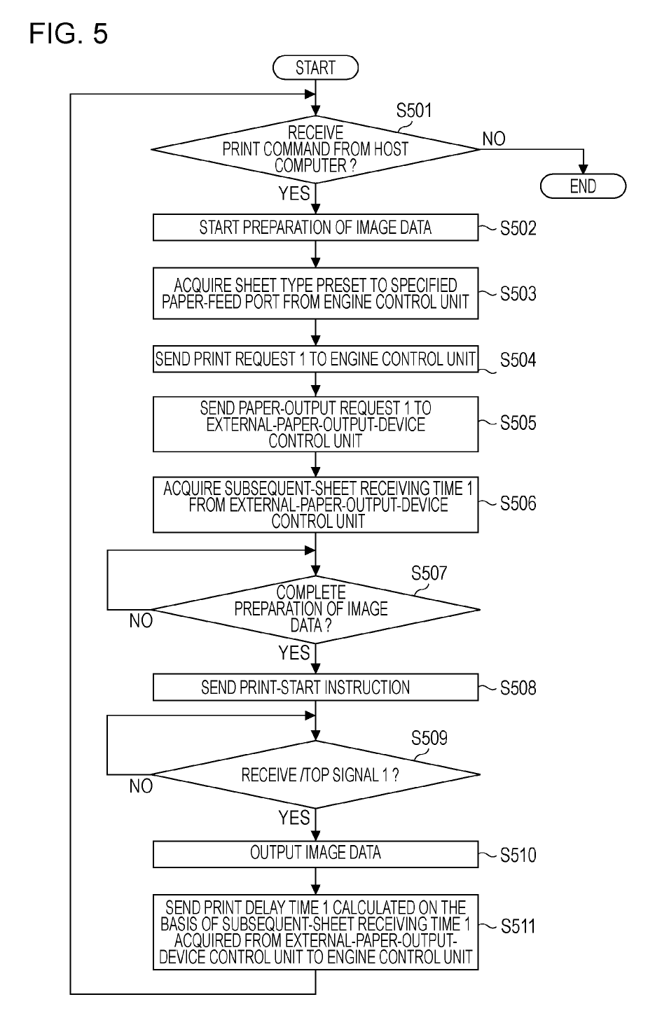

FIG. 5 shows an operation flow of the controller 201.

The controller 201, upon receipt of a print command from the host computer 200 (S501—YES), starts preparation of image data to be sent to the engine control unit 203 (S502).

The controller 201 requests information about sheet type preset to a paper-feed port to be specified in a print reservation, to the engine control unit 203, and acquires the information from the engine control unit 203 (S503). The controller 201 sends a print reservation 1 containing information necessary for printing specifying a paper-feed port, the sheet type acquired from the engine control unit 203, and the like to the engine control unit 203 (S504).

Then, the controller 201 sends the paper-output reservation 1 containing the information about sheet type acquired from the engine control unit 203, in addition to the paper-output conditions that specify required paper-output processing (stapling, etc.) and the like, to the external-paper-output-device control unit 202 (S505).

The controller 201 acquires a subsequent-sheet receiving time 1 calculated by the external-paper-output-device control unit 202, which represents a period of time from when it finishes the paper-output processing on the current sheet to when it becomes possible to receive the next sheet (S506).

The controller 201, upon completion of the preparation of the image data to be output to the engine control unit 203, sends a print-start instruction 1 to start printing to the engine control unit 203 (S507—YES, and S508).

The engine control unit 203 starts feeding of a sheet upon receipt of the print-start instruction 1, and sends a synchronizing signal (/TOP signal 1) for controlling the timing of image formation to the controller 201.

The controller 201, upon receipt of the /TOP signal 1 from the engine control unit 203 (S509—YES), outputs the image data to the engine control unit 203 in synchronization with the /TOP signal 1 (S510). The controller 201 sends a print delay time 1 calculated on the basis of the subsequent-sheet receiving time 1 acquired from the external-paper-output-device control unit 202 to the engine control unit 203 (S511).

In the exemplary case of the present embodiment, the information about sheet type preset to respective paper-feed ports is included in the paper-output reservation.

Examples of information about sheet type include, for example, the sheet size (such as A4 or B5), the sheet type (such as glossy paper, normal paper, rough paper, cardboard, thin paper, or OHP sheet). Not only the aforementioned information, but also information such as the sheet conveyance speed may be included in the paper-output reservation.

According to the present embodiment, by providing the external paper-output device with information about sheet (in particular, the sheet type), the processing performed by the paper-output device and the processing performed by the image forming apparatus can be synchronized. This provides an apparatus or a system with reduced waiting time during image formation and with an improved processing efficiency.

### Second Embodiment

In the first embodiment, a configuration in which the controller 201 acquires the information about sheet type from the engine control unit 203 prior to making a print reservation is described.

In the present embodiment, a configuration will be described in which the controller 201, when making a print reservation to the engine control unit 203, acquires the information about sheet type preset to a paper-feed port to be specified in a print reservation from the engine control unit 203 as a return status. The information acquired as a return status of the print reservation is the information about sheet type preset to the respective paper-feed ports. Examples of information about sheet type include, for example, the sheet size (such as A4 or B5), the sheet type (such as glossy paper, normal paper, rough paper, cardboard, thin paper, or OHP sheet). Not only the aforementioned information, but also information such as the sheet conveyance speed may be included in the paper-output reservation.

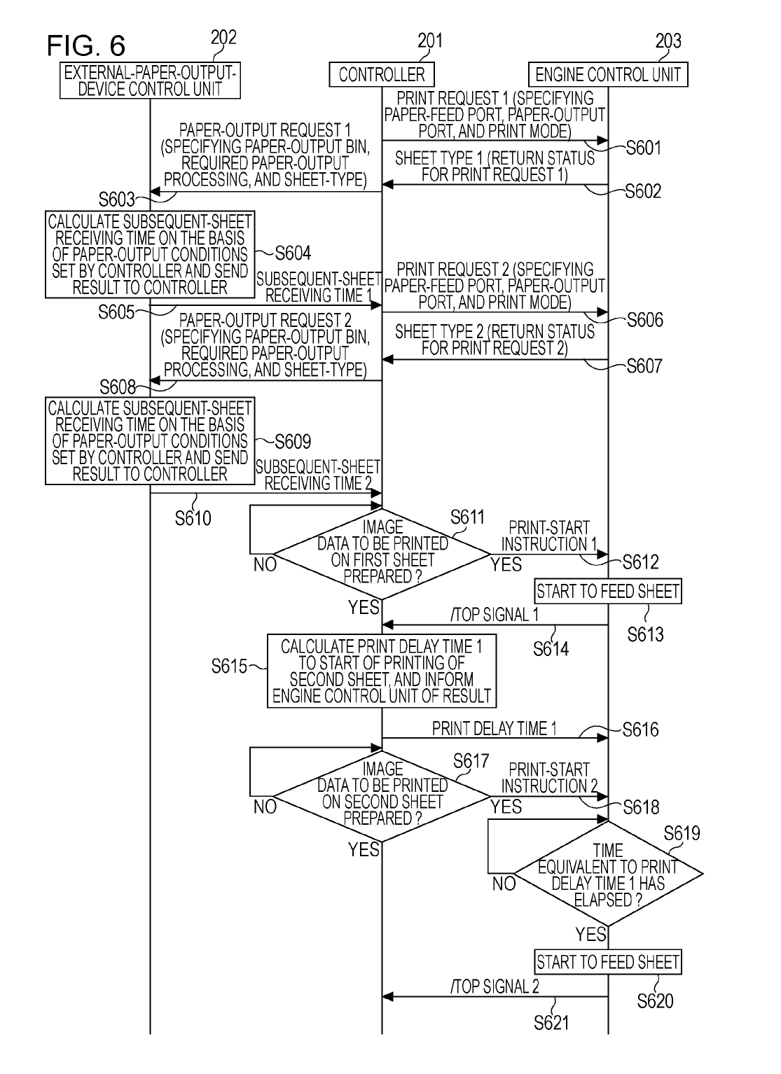

FIG. 6 shows an operation flow of the controller 201, the external-paper-output-device control unit 202, and the engine control unit 203.

The controller 201 sends a print reservation 1 containing information necessary for printing specifying a paper-feed port, a paper-output port, a print mode, and the like to the engine control unit 203. The controller 201 acquires information about sheet type (for example, sheet type 1: normal paper) preset to the paper-feed port specified in the print reservation 1 from the engine control unit 203 as return information (return status) for the print reservation 1 (S601 and S602).

The controller 201 sends a paper-output reservation 1 containing the information about sheet type acquired from the engine control unit 203, in addition to paper-output conditions specifying a paper-output port (bin), required paper-output processing (stapling, etc.), and the like, to the external-paper-output-device control unit 202 (S603).

The external-paper-output-device control unit 202, upon receipt of the paper-output reservation 1, calculates a subsequent-sheet receiving time 1, which represents a period of time from when it finishes paper-output processing under the specified conditions on a first sheet conveyed at a conveyance speed corresponding to the specified sheet type to when it becomes possible to receive the next sheet (a second sheet) (S604). The external-paper-output-device control unit 202 informs the controller 201 of the calculated subsequent-sheet receiving time 1 (S605).

In the case of the second (and subsequent) sheet, similarly to the first sheet, the controller 201 sends a print reservation 2 to the engine control unit 203 (S606). The controller 201 acquires the information about sheet type (sheet type 2: glossy paper) preset to the paper-feed port specified in the print reservation 2 as return information (return status) for the print reservation 2 from the engine control unit 203 (S607).

The controller 201 sends a paper-output reservation 2 containing the information about sheet type (sheet type 2) acquired from the engine control unit 203, in addition to paper-output conditions specifying a paper-output port (bin), required paper-output processing (stapling, etc.), and the like, to the external-paper-output-device control unit 202 (S608).

The external-paper-output-device control unit 202, upon receipt of the paper-output reservation 2, calculates a subsequent-sheet receiving time 2, which represents a period of time from when it finishes paper-output processing under the specified conditions on the second sheet conveyed at a conveyance speed corresponding to the specified sheet type (sheet type 2) to when it becomes possible to receive the next sheet (a third sheet) (S609).

The external-paper-output-device control unit 202 informs the controller 201 of the calculated subsequent-sheet receiving time 2 (S610).

The controller 201, upon completion of preparation of image data sent from the host computer (S611—YES), sends a print-start instruction 1 for the first sheet to the engine control unit 203 (S612).

The engine control unit 203 prepares to print upon receipt of the print-start instruction 1, starts feeding of a sheet from the specified paper-feed port, and outputs a synchronizing signal (/TOP signal 1) for controlling the timing with which the controller 201 outputs image data (S613 and S614).

The controller 201 outputs the image data in synchronization with the /TOP signal 1.

The controller 201, upon receipt of the /TOP signal 1, calculates a print delay time 1 between the subsequent-sheet receiving time 1 acquired from the external-paper-output-device control unit 202, at which reception of the second sheet becomes possible, and the start of the printing of the second sheet. The controller 201 then informs the engine control unit 203 of the print delay time 1 (S615 and S616).

The controller 201 informs the engine control unit 203 of a print-start instruction 2 for the second sheet upon completion of preparation of the image data to be printed on the second sheet (S617—YES, and S618).

The engine control unit 203 determines that, if a time equivalent to the print delay time 1 has already elapsed at the time of receipt of the print-start instruction 2 for the second sheet (S619—YES), the external paper-output device 30 can output the second sheet.

The time clocked by the timer 250 determines whether the time equivalent to the print delay time 1 has elapsed.

Then, the engine control unit 203 starts to feed the second sheet. If, it is determined that the time equivalent to the print delay time 1 has not elapsed in step S619 (S619—NO), the engine control unit 203 starts to feed the second sheet after the elapse of the time equivalent to the print delay time 1 (S620).

The engine control unit 203 starts to feed the second sheet from the specified paper-feed port, and outputs a synchronizing signal (/TOP signal 2) for controlling the timing with which the controller 201 outputs image data (S621).

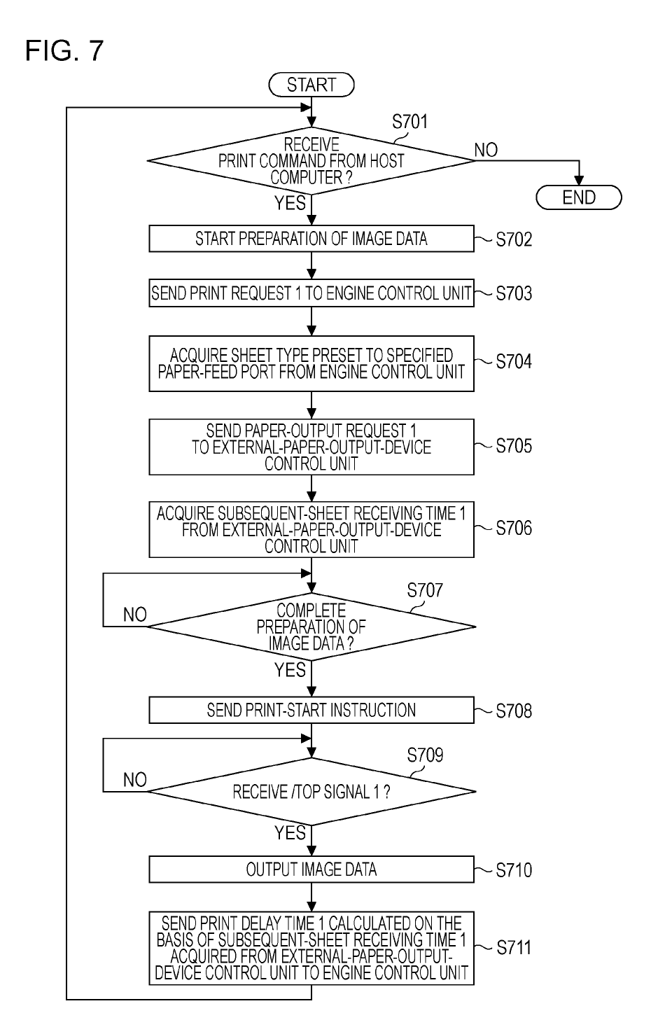

FIG. 7 shows an operation flow of the controller 201.

The controller 201, upon receipt of a print command from the host computer 200 (S701—YES), starts preparation of image data to be sent to the engine control unit 203 (S702).

Then, the controller 201 sends a print reservation 1 containing information necessary for printing specifying a paper-feed port, a paper-output port, a print mode, and the like to the engine control unit 203 (S703).

The controller 201 acquires information about the sheet type preset to the paper-feed port specified in the print reservation 1 from the engine control unit 203 as a return status for the print reservation 1 (S704).

The controller 201 sends a paper-output reservation 1 containing the information about sheet type acquired from the engine control unit 203, in addition to paper-output conditions specifying required paper-output processing (stapling, etc.) and the like, to the external-paper-output-device control unit 202 (S705).

The controller 201 acquires a subsequent-sheet receiving time 1 calculated by the external-paper-output-device control unit 202, which represents a period of time from when it finishes the paper-output processing on the current sheet to when it becomes possible to receive the next sheet (S706).

The controller 201 sends a print-start instruction 1 to start printing to the engine control unit 203 upon completion of the preparation of the image data to be output to the engine control unit 203 (S707—YES, and S708).

The engine control unit 203 starts feeding of a sheet upon receipt of the print-start instruction 1, and sends a synchronizing signal (/TOP signal 1) for controlling the timing of image formation to the controller 201.

The controller 201, upon receipt of the /TOP signal 1 from the engine control unit 203 (S709—YES), outputs the image data to the engine control unit 203 in synchronization with the /TOP signal 1 (S710). The controller 201 sends a print delay time 1 calculated on the basis of the subsequent-sheet receiving time acquired from the external-paper-output-device control unit 202 to the engine control unit 203 (S711).

According to the present embodiment, by providing the external paper-output device 30 with the information about sheet type, the processing performed by the paper-output device and the processing performed by the image forming apparatus can be synchronized. This provides an apparatus or a system with reduced waiting time during image formation and with an improved processing efficiency.

### Third Embodiment

In the above-described first and second embodiment, the controller 201 adds the information about sheet type acquired from the engine control unit 203 to a paper-output reservation to the external-paper-output-device control unit 202. The external-paper-output-device control unit 202 calculates a subsequent-sheet receiving time on the basis of the information about sheet type, and the controller 201 acquires the subsequent-sheet receiving time calculated by the external-paper-output-device control unit 202.

In the present embodiment, a configuration is described in which, if a sheet type specified in a paper-output reservation does not match a sheet type detected in performing printing, the subsequent-sheet receiving time is renewed on the basis of the information about sheet type detected at the latest. In the present embodiment, a print delay time is calculated on the basis of the renewed subsequent-sheet receiving time.

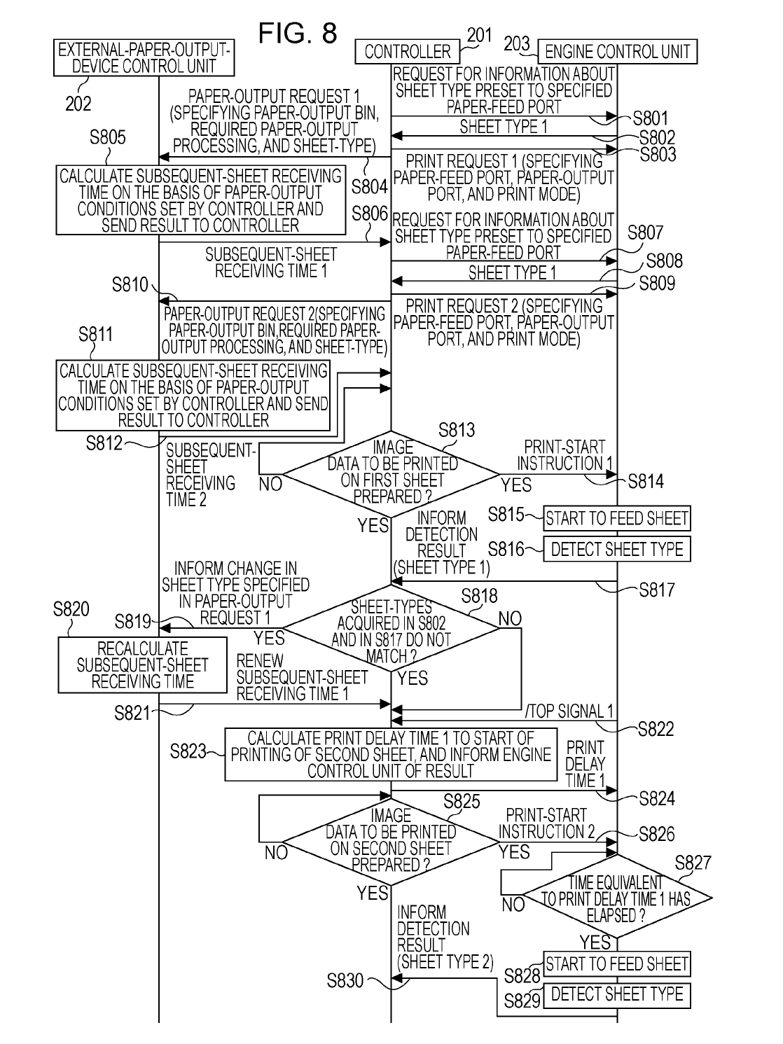

FIG. 8 shows an operation flow of the controller 201, the external-paper-output-device control unit 202, and the engine control unit 203.

The controller 201 sends a request for information about sheet type preset to a paper-feed port to be specified in a print reservation 1 to the engine control unit 203. The engine control unit 203, upon receipt of the request, sends the information about sheet type (for example, sheet type 1: normal paper) to the controller 201. The controller 201 acquires the information about sheet type (for example, sheet type 1: normal paper) preset to a paper-feed port to be specified in the print reservation 1 from the engine control unit 203 (S801 and S802).

Then, the controller 201 sends the print reservation 1 containing information necessary for printing specifying a paper-feed port, a paper-output port, a print mode, and the like to the engine control unit 203 (S803).

The controller 201 sends a paper-output reservation 1 containing the information about sheet type (sheet type 1) acquired from the engine control unit 203, in addition to paper-output conditions specifying a paper-output port (bin), required paper-output processing (stapling, etc.), and the like, to the external-paper-output-device control unit 202 (S804).

The external-paper-output-device control unit 202, upon receipt of the paper-output reservation 1, calculates a subsequent-sheet receiving time 1, which represents a period of time from when it finishes paper-output processing under the specified conditions on a first sheet conveyed at a conveyance speed corresponding to the specified sheet type (sheet type 1) to when it becomes possible to receive the next sheet (a second sheet). The external-paper-output-device control unit 202 informs the controller 201 of the calculated subsequent-sheet receiving time 1 (S805 and S806).

In the case of the second (and subsequent) sheet, similarly to the first sheet, the controller 201 acquires the information about sheet type (for example, sheet type 1: normal paper) preset to a paper-feed port to be specified in a print reservation 2 from the engine control unit 203 (S807 and S808).

Then, the controller 201 sends the print reservation 2 containing information necessary for printing specifying a paper-feed port, a paper-output port, a print mode, and the like to the engine control unit 203 (S809).

The controller 201 sends a paper-output reservation 2 containing the information about sheet type (sheet type 1) acquired from the engine control unit 203, in addition to paper-output conditions specifying a paper-output port (bin), required paper-output processing (stapling, etc.), and the like, to the external-paper-output-device control unit 202 (S810).

The external-paper-output-device control unit 202, upon receipt of the paper-output reservation 2, calculates a subsequent-sheet receiving time 2, which represents a period of time from when it finishes paper-output processing under the specified conditions on the second sheet conveyed at a conveyance speed corresponding to the specified sheet type (for example, sheet type 1) to when it becomes possible to receive the next sheet (a third sheet) (S811).

The external-paper-output-device control unit 202 informs the controller 201 of the calculated subsequent-sheet receiving time 2 (S812).

The controller 201, upon completion of preparation of image data sent from the host computer (S813—YES), sends a print-start instruction 1 for the first sheet to the engine control unit 203 (S814).

The engine control unit 203 prepares to print upon receipt of the print-start instruction 1, and starts feeding of a sheet from the specified paper-feed port (S815). The engine control unit 203 makes the sheet-type identification sensor 12 (shown in FIG. 1) detect the sheet type upon arrival of the sheet at the sheet-type identification sensor 12, and informs the detection result to the controller 201 (S816 and S817).

The controller 201 compares the sheet type acquired from the engine control unit 203 in step S802, and the sheet type (sheet type 1) acquired from the engine control unit 203 in step S817.

When these sheet types do not match (S818—YES), the controller 201 informs the external-paper-output-device control unit 202 of a change in sheet type (sheet type 1) specified in the paper-output reservation 1 for the first sheet (S819). More specifically, the controller 201 informs the external-paper-output-device control unit 202 of the information about sheet type detected by the sheet-type identification sensor 12.

The external-paper-output-device control unit 202 calculates a subsequent-sheet receiving time 1 again corresponding to the change in sheet type (S820)

The external-paper-output-device control unit 202 recalculates the subsequent-sheet receiving time 1 on the basis of the newly acquired information about sheet type. Then, the external-paper-output-device control unit 202 informs the controller 201 of the recalculation result as return information (return status) for the information of a change in sheet type (S821).

The engine control unit 203 outputs a synchronizing signal (/TOP signal 1) for controlling the timing with which the controller 201 outputs image data (S822).

The controller 201, upon receipt of a synchronizing signal (/TOP signal 1) from the engine control unit 203, calculates a delay time 1 between the subsequent-sheet receiving time 1 acquired from the external-paper-output-device control unit 202, at which reception of the second sheet becomes possible, and the start of the printing of the second sheet, on the basis of the renewed subsequent-sheet receiving time acquired in step S821. Then, the controller 201 informs the engine control unit 203 of the calculated delay time (print delay time 1) (S823 and S824).

The controller 201 informs the engine control unit 203 of a print-start instruction 2 (S826) for the second sheet upon completion of preparation of the image data to be printed on the second sheet (S825—YES). The engine control unit 203, if a time equivalent to the print delay time 1 has already elapsed at the time of receipt of the print-start instruction 2 for the second sheet (S827—YES), starts to feed the second sheet (S828). If the time equivalent to the print delay time 1 has not elapsed at the time of receipt of the print-start instruction 2 for the second sheet (S827—NO), the engine control unit 203 starts to feed the second sheet after the elapse of the time equivalent to the print delay time 1.

In step S829, the type of the second sheet is detected by the sheet-type identification sensor 12 (shown in FIG. 1), and the engine control unit 203 informs the controller 201 of the detection result (for example, sheet type 2: glossy paper).

Thereafter, steps S818 to S830 are repeated to process the subsequent sheets.

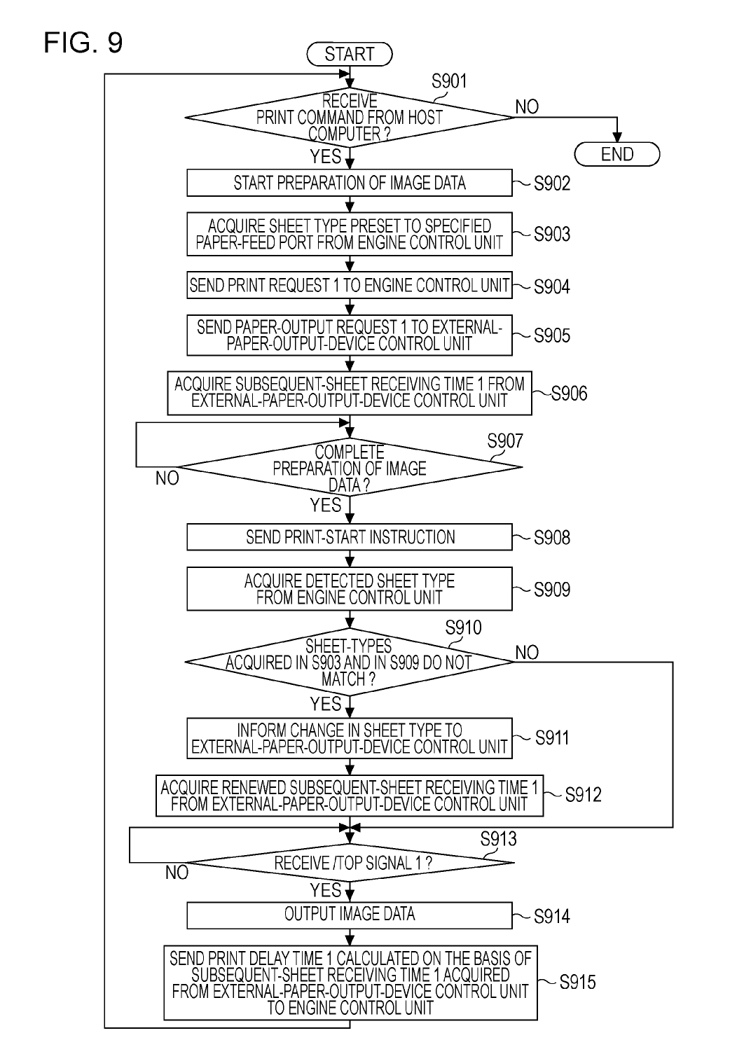

FIG. 9 shows an operation flow of the controller 201.

The controller 201, upon receipt of a print command from the host computer 200 (S901—YES), starts preparation of image data to be sent to the engine control unit 203 (S902).

The controller 201 acquires information about sheet type (sheet type: 1) preset to a paper-feed port specified in a print reservation 1 from the engine control unit 203.

The controller 201 sends the print reservation 1 containing information necessary for printing specifying a paper-feed port, the sheet type acquired from the engine control unit 203, and the like to the engine control unit 203 (S904).

Then, the controller 201 sends a paper-output reservation 1 containing the information about sheet type acquired from the engine control unit 203, in addition to paper-output conditions specifying required paper-output processing (stapling, etc.) and the like, to the external-paper-output-device control unit 202 (S905).

The controller 201 receives a subsequent-sheet receiving time 1 calculated by the external-paper-output-device control unit 202, which represents a period of time from when it finishes the paper-output processing on the current sheet to when it becomes possible to receive the next sheet (the second sheet) (S906).

The controller 201, upon completion of the preparation of the image data to be output to the engine control unit 203 (S907—YES), sends a print-start instruction to the engine control unit 203 (S908).

The engine control unit 203 starts feeding of a sheet from the specified paper-feed port upon receipt of the print-start instruction. The engine control unit 203 makes the sheet-type identification sensor 12 detect the sheet type upon arrival of the sheet at the sheet-type identification sensor 12. The controller 201 acquires the detected sheet type (S909).

The controller 201 compares the sheet type (sheet type 1) acquired in step S903 and the sheet type acquired as a result of the detection in step S909.

If these sheet types do not match (S910—YES), the controller 201 informs the external-paper-output-device control unit 202 of a change in sheet type (S911). For example, the controller 201 informs the external-paper-output-device control unit 202 of a change in sheet type from the sheet type (sheet type 1) acquired in step S903 to the sheet type acquired as a result of the detection in step S909.

The external-paper-output-device control unit 202 recalculates the subsequent-sheet receiving time 1 on the basis of information about sheet type newly acquired from the controller 201. Then, the external-paper-output-device control unit 202 informs the controller 201 of the recalculation result as return information (return status) for the information of a change in sheet type. The controller 201 acquires the recalculated subsequent-sheet receiving time 1 (S912).

The controller 201, upon receipt of the /TOP signal 1 from the engine control unit 203 (S913—YES), outputs the image data in synchronization with the /TOP signal 1 to the engine control unit 203 (S914).

The controller 201 sends a print delay time 1 calculated on the basis of the recalculated subsequent-sheet receiving time acquired from the external-paper-output-device control unit 202 to the engine control unit 203 (S915).

In the present embodiment, if the type of a sheet actually used in printing does not match the sheet type specified in a paper-output reservation, the subsequent-sheet receiving time can be recalculated on the basis of the sheet type obtained as a result of the detection. By correctly calculating the subsequent-sheet receiving time on the basis of the type of the sheet actually used, image formation can be performed without degrading performance of the image forming apparatus.

Further, in the present embodiment, when a sheet type (sheet type 1) contained in a paper-output reservation and a sheet type detected by the sheet-type identification sensor 12 match, a change in sheet type is not informed. That is, an operation of the image forming apparatus is controlled according to the already-calculated subsequent-sheet receiving time. If a user sets a favorite sheet type to the sheet type 1, which is included in a paper-output reservation, frequency of issuance of the information of a change in sheet type can be lowered.

Examples of the sheet-type identification sensor of the present embodiment include a sensor for reading an image on a surface of a sheet, a sensor for sensing the quantity of light reflected from a sheet, and a sensor for sensing the quantity of light transmitted through a sheet.

Modes for detecting the sheet type include a mode for performing sheet-type detection on all the sheets on a piece-by-piece basis, and a mode for performing sheet-type detection on only the first sheet stored in a cassette, not on the second and subsequent sheets. In either modes, the above-described first to third embodiments can be applied.

In the present embodiment, the processing performed by the paper-output device and the processing performed by the image forming apparatus can be synchronized by sharing the information about sheet type, whereby an image formation technology requiring a short waiting time in image formation and having a high processing efficiency can be provided.

### Other Embodiments

Needless to say, the present invention can be realized by providing a system or an apparatus with a storage medium in which a program code of software configured to implement the functions of the above-described embodiments. Of course, the present invention can also be realized by making a computer (or a CPU or a micro processing unit (MPU)) of the system or the apparatus read and execute the program code stored in the storage medium.

In such a case, the program code read from the storage medium implements the functions of the above-described embodiments. Accordingly, the storage medium storing the program code constitutes the present invention.

Examples of the storage medium for providing the program code include, for example, a flexible disk, a hard disk, an optical disk, a magneto-optical disk, a compact disc read-only memory (CD-ROM), a compact disc recordable (CD-R), a nonvolatile memory card, and a read-only memory (ROM).

By a computer reading and executing the program code, the functions of the above-described embodiments can be implemented. Needless to say, a case in which an operating system (OS) running on a computer performs a part or the entirety of the processing, in accordance with the instruction of the program code, to implement the functions of the above-described embodiments also falls within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-028444 filed Feb. 7, 2007, which is hereby incorporated by reference herein in its entirety.

What is claimed is:

1. An image forming apparatus to which a paper-output device configured to process a sheet after image formation can be attached, the apparatus comprising:
a paper-feed unit configured to feed a sheet for image formation;
a detection unit configured to detect a type of the sheet fed from the paper-feed unit;
an image forming section configured to form an image on the sheet fed from the paper-feed unit; and
a control unit configured to determine a sheet-feed timing based on a sheet-processing time used by the paper-output device corresponding to a preset sheet type;
wherein, if the preset sheet type matches the type of the sheet detected by the detection unit, the control unit determines the sheet-feed timing based on the sheet-processing time corresponding to the preset sheet type, and
wherein, if the preset sheet type does not match the type of the sheet detected by the detection unit, the control unit determines the sheet-feed timing based on the sheet-processing time corresponding to the type of the sheet detected by the detection unit.

2. The image forming apparatus according to claim 1, wherein the paper-output device comprises a paper-output-device control unit configured to control sheet processing, and configured to calculate the sheet-processing time based on the sheet type acquired from the control unit.

3. The image forming apparatus according to claim 1, further comprising:
a clocking unit configured to start clocking when the paper-feed unit starts feeding of a first sheet; and
a determining unit configured to determine whether a time clocked by the clocking unit has exceeded a time equivalent to the sheet-feed timing,
wherein, if the determining unit determines that the time clocked by the clocking unit has exceeded the time equivalent to the sheet-feed timing, the paper-feed unit starts feeding of a second sheet.

4. A method for controlling feeding of a sheet in an image forming apparatus to which a paper-output device configured to process a sheet after image formation can be attached, the method comprising:
sending information about processing to be performed by the paper-output device to the paper-output device, the information including information about sheet type preset to a paper-feed unit of the image forming apparatus and information to control the paper-output device configured to perform paper-output processing of a sheet after image formation;
calculating a sheet-processing time used by the paper-output device based on the information about the processing to be performed by the paper-output device;
determining a sheet-feed timing in the image forming apparatus the calculated sheet-processing time; and
starting feeding of a sheet in accordance with the sheet-feed timing set in the determining.

5. A method for controlling feeding of a sheet in an image forming apparatus to which a paper-output device configured to process a sheet after image formation can be attached, the method comprising:
sending information about processing to be performed by the paper-output device to the paper-output device, the information including information about sheet type preset to a paper-feed unit of the image forming apparatus;
calculating a sheet-processing time used by the paper-output device based on the information about the processing to be performed by the paper-output device;
detecting a type of a sheet fed from the paper-feed unit;
renewing the sheet-processing time calculated in the calculating, if the sheet type preset to the paper-feed unit does not match the detected type of the sheet; and
starting feeding of the sheet in accordance with the renewed sheet-processing time.
